(19) United States
(12) Patent Application Publication
(10) Pub. No.: US 2026/0328316 A1
(43) Pub. Date: Oct. 22, 2026

(54) COCKTAIL MACHINE INCLUDING A REFRIGERATED COMPARTMENT

(71) Applicant: ASYTEC, Paris (FR)

(72) Inventor: Nicolas MAZEAUD, Paris (FR)

(73) Assignee: AYSTEC, Paris (FR)

(21) Appl. No.: 19/573,203

(22) Filed: Mar. 20, 2026

(30) Foreign Application Priority Data
Mar. 21, 2025 (FR) 2502931

(51) Int. Cl. F16L 13/14; F16L 13/08; F25B 41/40

(52) U.S. Cl. CPC F16L 13/141; F16L 13/08; F25B 41/40

(57) ABSTRACT

A cocktail machine having a refrigerated compartment and a refrigeration unit with a compressor, a condenser, expansion means, an evaporator configured to transfer heat from the refrigerated compartment to a heat transfer fluid, and a heat transfer network comprising a second connection for connecting an outlet duct of the condenser and an inlet duct of the expansion means, an inlet connection for connecting an outlet duct of the expansion means and an inlet duct of the evaporator, and an outlet connection for connecting an outlet duct of the evaporator and an inlet duct of the compressor, the second connection and the outlet connection, and/or the outlet connection and the inlet connection, each comprising a mechanical connection comprising a crimping ring configured to connect the inlet duct and the corresponding outlet duct in a sealed manner.

### TECHNICAL FIELD

The invention relates to a cocktail machine comprising a refrigerated compartment and a method for manufacturing such a machine.

### BACKGROUND

A cocktail machine makes it possible to make cocktails according to predefined recipes using ingredients provided to the cocktail machine by the machine user. Each liquid ingredient is stored in its own receptacle, and the cocktail machine comprises a hydraulic network configured to withdraw specifically in each receptacle a given volume of the ingredient contained therein. A control unit determines the different volumes to be withdrawn according to the recipe to be prepared and controls their withdrawal. The hydraulic network is further configured so that each withdrawn volume is delivered, typically by a dispensing head, into a final receptacle, for example a glass of the user.

Conventionally, the container of each ingredient is a bag-in-box (BIB), which consists of a plastic bag disposed in a cardboard box, initially filled with the ingredient and hermetically connected to the hydraulic network of the cocktail machine. When the volume of ingredient contained in the plastic bag decreases by withdrawal by the cocktail machine, the plastic bag simultaneously contracts due to the pressure applied by the outside air on the bag, which allows withdrawal to continue as normal. This makes it possible to prevent the introduction of air into the bag and therefore prevents oxidation of the liquid contained therein. In comparison, when the receptacle is not deformable, typically when the receptacle is a bottle, it is necessary to have outside air enter the receptacle in order to empty it. However, the liquid in the bottle then comes into contact with outside air, which then shortens its shelf-life.

However, the main disadvantages of bag-in-box containers are, on the one hand, that the user is required to procure bag-in-box containers from the machine vendor, which makes running the cocktail machine extremely expensive, and, on the other hand, that they cannot use the ingredients they usually otherwise use.

It has therefore been proposed to store ingredients in more conventional receptacles, such as bottles, and to integrate a cooling system into the cocktail machine in order to improve the shelf-life of liquids contained in these bottles. According to this configuration, the ingredients would be exposed to air, but stored chilled, which would make it possible to store the ingredients for a long time while allowing the user to use their own bottles.

However, adding a cooling system to the cocktail machine increases its size drastically, as it is necessary to house, in addition to bottles and the liquid dispensing circuit, a compressor, a condenser, an expansion valve and an evaporator and to connect them by suitable ducts in order to allow the circulation of a heat transfer fluid. However, a cocktail machine is often intended to be used in a bar or restaurant where the space available is limited.

### BRIEF DESCRIPTION

One aim of the invention is to design a cocktail machine which is compact while allowing the user to use their usual ingredients and guaranteeing a long shelf-life for these ingredients. To this end, the invention provides a cocktail machine and a method according to the appended claims.

The use of mechanical connections to connect the evaporator to the expansion means and to the compressor, or to connect the assembly consisting of the expansion means and the evaporator to the condenser and to the compressor, rather than soldering the ducts, makes it possible to reduce the size of the cooling system significantly. Indeed, producing a solder joint requires use of a flame which implies a substantial free volume around the parts to be soldered. However, positioning the evaporator inside the refrigerated compartment of the cocktail machine implies that said evaporator can only be connected to the rest of the cooling system, optionally pre-assembled, once said evaporator is in place in the compartment. If the cooling system is fitted into an overly small volume, there is a substantial risk of the flame damaging the various pre-assembled cocktail machine elements.

Furthermore, the refrigerated compartment advantageously makes it possible to store the user's ingredients chilled and therefore increase their shelf-life, without the user having to use bag-in-box containers. This furthermore allows them to use any type of ingredient, the user not being constrained by the shape or configuration of the receptacle.

The invention relates to a cocktail machine comprising:
a refrigerated compartment configured to accommodate at least one fluid container,
a refrigeration unit comprising a compressor configured to compress a heat transfer fluid,
   a condenser configured to condense the heat transfer fluid into a liquid, expansion means configured to reduce a temperature of the liquid, an evaporator adjacent to the refrigerated compartment and configured to transfer heat from the refrigerated compartment to the liquid, and a heat transfer network configured to place the compressor, the condenser, the expansion means and the evaporator in fluidic communication,
   the heat transfer network comprising a first connection configured to connect an outlet duct of the compressor and an inlet duct of the condenser, a second connection configured to connect an outlet duct of the condenser and an inlet duct of the expansion means, an inlet connection configured to connect an outlet duct of the expansion means and an inlet duct of the evaporator, and an outlet connection configured to connect an outlet duct of the evaporator and an inlet duct of the compressor,
   wherein the second connection and the outlet connection, and/or the outlet connection and the inlet connection, each comprise a mechanical connection comprising a crimping ring configured to connect the inlet duct and the corresponding outlet duct in a sealed manner.

According to other optional features of the cocktail machine taken alone or in combination where technically possible:
the connection of the mechanical connections to the corresponding inlet and outlet ducts is devoid of a weld or solder joint;
the second connection and the outlet connection comprise the mechanical connection, the inlet connection comprising a solder joint;
the evaporator is disposed inside the refrigerated compartment, a first wall of the refrigerated compartment comprising at least one passage orifice, the inlet duct and/or the outlet duct of the evaporator passing through said passage orifice;
the evaporator comprises a first plate and a second plate fastened against the first plate, at least the first plate comprising a recess, such that said recess of the first plate closed by the second plate forms a duct for circulating the heat transfer fluid in the evaporator, the evaporator being disposed against an inner surface of a second wall of the refrigerated compartment;
the compressor comprises a rechargeable battery;
the cocktail machine further comprises a fan configured to cool the condenser;
the cocktail machine further comprises an additional compartment comprising an evacuation grille, the condenser, the compressor and the fan being disposed inside said additional compartment, the condenser being disposed between the fan and the evacuation grille;
an axis of rotation of the fan is perpendicular to a main plane of a heating duct of the condenser, and the inlet duct and the outlet duct of the condenser are each disposed between the fan and the evacuation grille;
the condenser comprises a housing, the fan being mounted on the condenser housing.

The invention also relates to a method for manufacturing a cocktail machine as described above comprising the following steps:
disposing the refrigeration unit in the cocktail machine, and
connecting in a sealed manner the second connection and the outlet connection, and/or the outlet connection and the inlet connection to the corresponding inlet and outlet ducts via mechanical connections comprising a crimping ring.

According to other optional features of the cocktail machine taken alone or in combination where technically possible:
the method further comprises disposing the fan in the additional compartment;
prior to disposing the refrigeration unit in the cocktail machine and connecting in a sealed manner the second connection and the outlet connection, on the corresponding inlet and outlet ducts via the mechanical connections, the method further comprises:
   making the first connection by soldering or by welding so as to connect the outlet duct of the compressor and the inlet duct of the condenser,
   making the inlet connection by soldering or by welding so as to connect the outlet duct of the expansion means to the inlet duct (8) of the evaporator;
prior to disposing the refrigeration unit in the cocktail machine and connecting in a sealed manner the outlet connection and the inlet connection, on the corresponding inlet and outlet ducts via the mechanical connections, the method comprises:
making the first connection by soldering or by welding so as to connect the outlet duct of the compressor and the inlet duct of the condenser,
making the second connection by soldering or by welding so as to connect the outlet duct of the condenser and the inlet duct of the expansion means.

### BRIEF DESCRIPTION OF THE FIGURES

Further features and advantages will become apparent from the following detailed description, with reference to the attached drawings, in which:

FIG. 1 shows a cocktail machine according to one embodiment;

FIG. 2 shows a sectional view of a cocktail machine according to one embodiment wherein the distribution network of the cocktail machine configured to deliver a cocktail can be seen, as well as the condenser, the expansion valve and the compressor of the refrigeration unit;

FIG. 3 shows a sectional view of a cocktail machine according to one embodiment wherein the evaporator of the refrigeration unit can be seen;

FIG. 4 shows a view according to a first cross-section of the refrigeration unit of a cocktail machine according to one embodiment;

FIG. 5 shows a view according to a second cross-section, perpendicular to the first cross-section, of the refrigeration unit of a cocktail machine according to one embodiment;

FIG. 6 shows a view of a condenser assembled with a fan in a refrigeration unit of a cocktail machine according to one embodiment;

FIG. 7 shows a mechanical connection in the refrigeration group of a cocktail machine according to one embodiment.

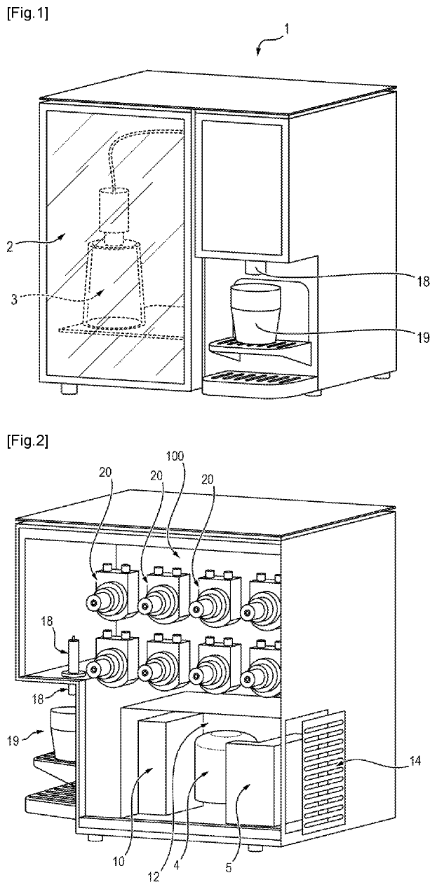

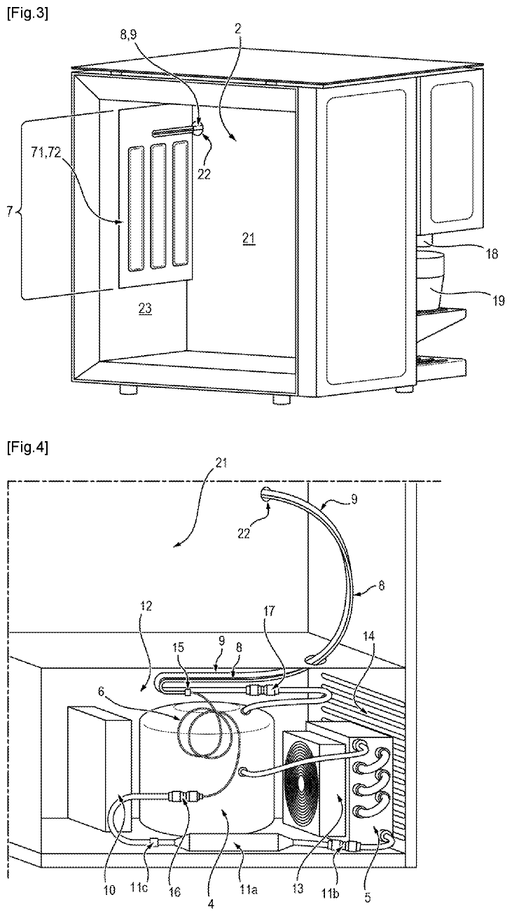

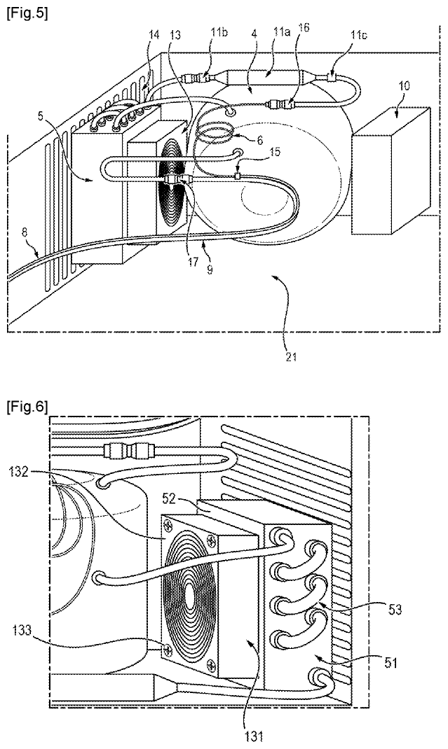

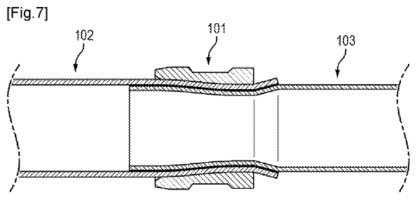

For reasons of readability, the drawings are not necessarily to scale.

### DETAILED DESCRIPTION OF EMBODIMENTS

### Cocktail Machine

A cocktail machine 1 comprises a refrigerated compartment 2 configured to accommodate at least one fluid container 3. The fluid container 3 may comprise any container capable of receiving a fluid, such as a bottle, a can, a jar, or even a bag-in-box.

### Refrigeration Unit

The cocktail machine 1 further comprises a refrigeration unit comprising a compressor 4, a condenser 5, expansion means (here, a capillary tube 6), an evaporator 7 and a heat transfer network configured to place the compressor 4, the condenser 5, the capillary tube 6 and the evaporator 7 in fluidic communication. Where applicable, the refrigeration unit may also comprise a dehumidifying filter 11a positioned between the condenser 5 and the capillary tube 6. The refrigeration unit is in addition housed directly inside the cocktail machine 1.

The refrigeration unit further comprises a heat transfer fluid configured to circulate, in a closed loop and successively, through the compressor 4, the condenser 5, the capillary tube 6 and the evaporator 7 via connections of the heat transfer network. During a cycle, the heat transfer fluid is configured to withdraw heat from the refrigerated compartment 2 at the evaporator 7 and return said heat at the condenser 5. During a cycle, the heat transfer fluid is caused to change phase, temperature and/or pressure.

Each element is described more specifically hereinafter.

“Connection” will be understood to mean the assembly between two ducts, and a connection can therefore comprise a mechanical part or a solder joint.

### Capillary Tube 6

The capillary tube 6 is configured to reduce a temperature of the hot liquid heat transfer fluid delivered by an inlet duct of the capillary tube 6 and to deliver the cold liquid heat transfer fluid by an outlet duct of the capillary tube 6.

An inlet duct 8 of the evaporator 7 is configured to be connected to the outlet duct of the capillary tube 6, in a sealed manner via an inlet connection 15, such that the cold liquid heat transfer fluid circulates from the capillary tube 6 to the evaporator 7 successively via the outlet duct of the capillary tube 6, the inlet connection 15 and the inlet duct 8 of the evaporator 7.

### Evaporator 7

The evaporator 7 is adjacent to the refrigerated compartment 2 and is configured to transfer heat from the refrigerated compartment 2 to the cold liquid heat transfer fluid delivered by the inlet duct 8 of the evaporator 7, so as to at least partially evaporate said heat transfer fluid, and to deliver by an outlet duct 9 of the evaporator 7 the at least partially gaseous heat transfer fluid.

The evaporator 7 typically comprises a cooling duct extending between the inlet duct 8 of the evaporator 7 and the outlet duct 9 of the evaporator 7 and configured to circulate the cold liquid heat transfer fluid from the inlet duct 8 of the evaporator 7 to the outlet duct 9 of the evaporator 7. Each duct among the inlet duct 8 of the evaporator 7, the cooling duct of the evaporator 7 and the outlet duct 9 of the evaporator 7 may be one-piece (monolithic) with the duct adjacent to it, or on the contrary be mechanically connected to it, for example by a connection as described hereinafter.

In one embodiment, the cooling duct of the evaporator 7 comprises at least one section, having a coil shape, the evaporator 7 being configured so that the transfer of heat from the refrigerated compartment 2 to the heat transfer fluid takes place at least at such a coil-shaped section. The coil-shaped geometry advantageously makes it possible to increase the exchange surface area between the heat transfer fluid and the air contained in the refrigerated compartment 2 while limiting the size of the evaporator 7.

The evaporator 7 may be disposed at least partially inside the refrigerated compartment 2. For example, at least one section of the cooling duct, typically a coil-shaped duct section, may be disposed inside the refrigerated compartment 2. In one embodiment, the inlet duct 8 and the outlet duct 9 of the evaporator 7 may also be disposed inside the refrigerated compartment 2.

An inlet duct of the compressor 4 is configured to be connected to the outlet duct of the evaporator 7, in a sealed manner via an outlet connection 17, such that the at least partially gaseous heat transfer fluid circulates from the evaporator 7 to the compressor 4 successively via the outlet duct 9 of the evaporator 7, the outlet connection 17 and the inlet duct of the compressor 4.

When the evaporator 7 is at least partially disposed inside the refrigerated compartment 2, at least one passage orifice 22 is formed in a connecting wall 21 of the refrigerated compartment 2 for connecting the evaporator 7 to the capillary tube 6 and connecting the evaporator 7 to the compressor 4. In one embodiment, the outlet duct of the capillary tube 6 and the inlet duct of the compressor 4 pass through the at least one passage orifice 22 to open into the refrigerated compartment 2, such that the outlet duct of the capillary tube 6 and the inlet duct of the compressor 4 are respectively connected to the inlet duct 8 of the evaporator 7 and the outlet duct 9 of the evaporator 7 in the refrigerated compartment 2. In other words, the inlet connection 15 and the outlet connection 17 are disposed inside the refrigerated compartment 2. In another embodiment, the inlet duct 8 and the outlet duct 9 of the evaporator 7 pass through the at least one passage orifice 22, such that the inlet duct 8 and the outlet duct 9 of the evaporator 7 are respectively connected to the outlet duct of the capillary tube 6 and to the inlet duct of the compressor 4 outside the refrigerated compartment 2, preferably inside the cocktail machine 1. In other words, the inlet connection 15 and the outlet connection 17 are disposed outside the refrigerated compartment 2, preferably inside the cocktail machine 1. In another embodiment, the inlet duct 8 of the evaporator 7 and the inlet duct of the compressor 4 pass through the at least one passage orifice 22. In another embodiment, the outlet duct 9 of the evaporator 7 and the outlet duct of the capillary tube 6 pass through the at least one passage orifice 22.

In an alternative example (variant not shown), the at least one passage orifice 22 allows only the connection of the evaporator 7 to the capillary tube 6, the inlet duct 8 of the evaporator 7 or the outlet duct of the capillary tube 6 passing through the at least one passage orifice 22, and, the connecting wall 21 (or another wall) of the refrigerated compartment 2 further comprises an additional orifice allowing the connection of the evaporator 7 to the compressor 4, the outlet duct 9 of the evaporator 7 or the inlet duct of the compressor 4 passing through the additional orifice.

In an exemplary embodiment, the evaporator 7 may comprise a first plate 71 and a second plate 72 fastened against the first plate 71, at least the first plate 71 comprising a recess, such that said recess of the first plate 71 closed by the second plate 72 forms at least one section of the cooling duct of the evaporator 7, typically a coil-shaped duct section. When the first plate 71 and the second plate 72 each comprise a recess, the recess of the first plate 71 is preferably disposed facing the recess of the second plate 72, such that the two recesses together form the section of the cooling duct of the evaporator 7. The first plate 71 and the second plate 72 may be disposed inside the refrigerated compartment 2, for example against a wall of the refrigerated compartment 2 referred to as cooling wall 23 of said refrigerated compartment 2. The connecting wall 21 and the cooling wall 23 may be different. Alternatively, the connecting wall 21 and the cooling wall 23 may be merged.

### Compressor 4

The compressor 4 is configured to compress and heat the gaseous heat transfer fluid delivered by the inlet duct of the compressor 4 and to deliver the hot compressed gaseous heat transfer fluid by the outlet duct of the compressor 4.

In one embodiment, the compressor 4 comprises a rechargeable battery in order to reduce its size in the refrigeration unit. For example, the compressor 4 is configured to operate with a power supply voltage between 10 V and 45 V. Indeed, a compressor comprising a rechargeable battery, in particular when it is configured to operate with a power supply voltage in the range mentioned above, is advantageously more compact than a compressor configured to be connected to the electrical mains, and meets the need to obtain the most compact cocktail machine, and therefore refrigeration unit, possible. In addition, a compressor with a rechargeable battery is specially designed to be mobile and has superior shock resistance. Finally, a compressor comprising a rechargeable battery advantageously consumes little energy for its operation.

In particular, the BD35K model from Secop is particularly space-saving, while having sufficient power to be capable of cooling a refrigerated compartment comprising several bottles.

### Condenser 5 and Additional Compartment 12

An inlet duct of the condenser 5 is configured to be connected to the outlet duct of the compressor 4, in a sealed manner via a first connection, such that the hot compressed gaseous heat transfer fluid circulates from the compressor 4 to the condenser 5 successively via the outlet duct of the compressor 4, the first connection and the inlet duct of the condenser 5.

The condenser 5 is configured to condense into liquid the hot compressed gaseous heat transfer fluid delivered by the inlet duct of the condenser 5 and to deliver the hot liquid heat transfer fluid by an outlet duct of the condenser 5.

Typically, the condenser 5 comprises a heating duct 53 which extends between the inlet duct of the condenser 5 and the outlet duct of the condenser 5 and the condenser 5 is configured to circulate the hot compressed gaseous heat transfer fluid in said heating duct 53 from the inlet duct of the condenser 5 to the outlet duct of the condenser 5, which during this circulation, transfers heat to the air outside the heating duct 53. Preferably, the heating duct 53 of the condenser 5 comprises at least one coil-shaped section advantageously making it possible to increase the exchange surface area between the heat transfer fluid and the outside air.

Each duct between the inlet duct of the condenser 5, the heating duct 53 of the condenser 5 and the outlet duct of the condenser 5 may be one-piece (monolithic) with the duct adjacent to it, or on the contrary be mechanically connected to it, for example by a connection.

In one embodiment, the cocktail machine 1 comprises a fan 13 configured to cool said condenser 5. The fan 13 advantageously makes it possible to reduce the size of the refrigeration unit, and more broadly of the cocktail machine 1. Indeed, without a fan 13, the condenser 5 heats the ambient air substantially. In this configuration, if the compressor 4 is disposed too close to the condenser 5, there is a risk of overheating said compressor 4, in particular the electronic components comprised in the compressor 4, and therefore of breaking the compressor 4. If the refrigerated compartment 2 is too close to the condenser 5, there is also a risk of heating the liquid receptacles stored in the refrigerated compartment 2 which on the contrary it is sought to cool. The fan therefore advantageously makes it possible to move certain elements of the refrigeration unit, such as the compressor and the expansion valve, as well as the refrigerated compartment 2 closer to the condenser 5. The cocktail machine 1 can thus be more compact, while making it possible to cool the receptacles stored in the refrigerated compartment 2 effectively and without damaging the compressor 4.

Preferably, the fan 13 comprises a rotor of which the axis of rotation is perpendicular to a main plane of the coil-shaped section of the heating duct 53 of the fan 13, which makes it possible to create the convection motion to dissipate air heated by the condenser 5 as effectively as possible.

Typically, the cocktail machine 1 further comprises an additional compartment 12 comprising an evacuation wall itself comprising an evacuation grille 14, and the condenser 5 and the fan 13 are disposed inside said additional compartment 12, such that the fan 13, the condenser 5 and the evacuation grille 14 are in fluidic communication, in other words, rotating the fan 13 generates an air flow which evacuates the air from the additional compartment 12 heated by the condenser 5 through the evacuation grille 14.

For example, the condenser 5 may be disposed between the fan 13 and the evacuation grille 14.

Where applicable, the compressor 4, a control unit 10 of the compressor 4 (configured particularly to control a speed of the compressor 4) and/or the capillary tube 6 may also be disposed inside the additional compartment 12. Furthermore, at least one opening may be formed in at least one junction wall of the additional compartment 12 to allow the connection of the capillary tube 6 to the evaporator 7 and the evaporator 7 to the compressor 4. Typically, the inlet duct 8 of the evaporator 7 and/or the outlet duct 9 of the evaporator 7 may be extended, such that the inlet duct 8 of the evaporator 7 and/or the outlet duct 9 of the evaporator 7 are respectively connected to the outlet duct of the capillary tube 6 and to the inlet duct of the compressor 4 inside the additional compartment 12. In other words, the inlet connection 15 and/or the outlet connection 17 may be disposed inside the additional compartment 12.

The fan 13 advantageously makes it possible to obtain an additional compartment 12 inside which both the compressor 4, the control unit 10 of the compressor 4, the capillary tube 6 and the condenser 5 are disposed while remaining very compact, because, as mentioned above, the convection motion generated by the fan 13 advantageously makes it possible to evacuate the air heated by the condenser 5 and therefore to prevent the temperature in the additional compartment 12, though confined, from reaching excessive temperatures which could damage the compressor 4 or the control unit 10 of the compressor 4. For example, the fan 13 may be disposed between the condenser 5 and the compressor 4, and the compressor 4 between the control unit 10 and the fan 13. Alternatively, the control unit 10 may be disposed between the fan 13 and the compressor 4.

Thanks to the fan 13, the additional compartment 12 may be adjacent to the refrigerated compartment 2, because, as mentioned above, the convection motion generated by the fan 13 advantageously makes it possible to prevent an excessive increase in the temperature in the additional compartment 12 and therefore heating of any common wall between the additional compartment 12 and the refrigerated compartment 2, which would have the consequence of also heating the interior of the refrigerated compartment 2 by thermal conduction of the heat through the common wall. The cocktail machine which would thus comprise an additional compartment 12 adjacent to the refrigerated compartment 2 would advantageously be more compact. Thus, in an exemplary embodiment, the additional compartment 12 is adjacent to the refrigerated compartment 2 by a common wall to the additional compartment 12 and the refrigerated compartment 2. For example, the common wall may be the connecting wall 21 of the refrigerated compartment, which advantageously makes it possible to reduce the length of the connecting ducts. When the additional compartment 12 is adjacent to the refrigerated compartment 2, the evacuation grille 14 does not open on the side of the refrigerated compartment 2.

Preferably, for better air renewal, the evacuation grille 14 opens outside of the cocktail machine 1, thus placing the air inside the additional compartment 12 and the air outside the cocktail machine 1 in contact.

The additional compartment 12 may further comprise an air inlet into a wall of the additional compartment 12 which may be adjacent to or opposite the evacuation grille 14, for example parallel or perpendicular to the evacuation grille 14. Preferably, the air inlet opens outside the cocktail machine 1 and is configured such that rotating the rotor of the fan 13 causes an air flow through, successively, the air inlet, the fan 13, the condenser 5 and the evacuation grille 14. For example, the air inlet is comprised in a wall of the additional compartment 12 perpendicular to the evacuation grille 14 at the fan 13.

In an exemplary embodiment, the condenser 5 may comprise a housing 51, the fan 13 being mounted on the housing 51 of the condenser 5. Typically, the heating duct 53 of the condenser 5 is housed at least partially inside the housing 51. For example, a housing 131 of the fan 13 may be fastened to a first ventilation wall 52 of the housing 51 of the condenser 5, by any suitable fastening means, the rotor being housed inside the housing 131 and movable relative to said housing. The first ventilation wall 52 of the housing 51 of the condenser 5 adjacent to the housing 131 of the fan 13 is typically configured to allow the circulation of the air flow set in motion by the fan rotor 13 up to the heating duct 53. For example, the first ventilation wall 52 of the housing 51 of the condenser 5 comprises at least two orifices, preferably four orifices, configured to coincide with respective orifices in the housing 131 of the fan 13, the fastening means comprising for example a screw 133 inserted into each orifice of the ventilation wall 52 of the housing 51 of the condenser 5 by a wall 132 of the housing 131 of the fan 13 opposite the housing of the condenser 5. Preferably, the housing 51 further comprises a second ventilation wall opposite the first open wall 52 to allow the circulation of the air flow heated by the heating duct 53 out of the condenser 5.

Even more preferably, the second open wall opposite the first wall 52 is disposed against the evacuation grille 14, which makes it possible to ensure more effective evacuation of the air heated by the condenser 5.

### Outlet Duct of the Expansion Valve 5

The outlet duct of the expansion valve 5 is connected to the inlet duct of the capillary tube 6 by a second connection 16, such that the hot liquid heat transfer fluid circulates from the condenser 5 to the capillary tube 6 through, successively, the outlet duct of the condenser 5, the second connection 16 and the inlet duct of the capillary tube 6.

In a particular embodiment, the outlet duct of the expansion valve 5 comprises an upstream section, an intermediate section and a downstream section, the intermediate section forming the dehumidifying filter 11a. For example, the upstream section of the outlet duct of the expansion valve 5 may be connected to the intermediate section of the outlet duct of the expansion valve 5 by a third connection 11b. For example, the intermediate section of the outlet duct of the expansion valve 5 may be connected to the downstream section of the outlet duct of the expansion valve 5 by a fourth connection 11c.

### Heat Transfer Network Connections

In a first embodiment, the second connection 16 and the outlet connection 17 each comprise a mechanical connection comprising a crimping ring configured to connect the inlet duct and the corresponding outlet duct in a sealed manner.

A cocktail machine comprising a mechanical connection comprising a crimping ring configured to connect in a sealed manner, on the one hand, the capillary tube 6 to the condenser 5 and, on the other hand, the evaporator 7 to the compressor 4 may advantageously be manufactured by connecting, without soldering and without welding, two sub-assemblies of the refrigeration unit prepositioned in the cocktail machine: a first sub-assembly comprising the evaporator 7 and the capillary tube 6, the evaporator 7 having been at least partially prepositioned inside the refrigerated compartment 2 and the capillary tube 6 having been pulled for example through the passage orifice 22, and a second sub-assembly comprising the compressor 4, the condenser 5 and optionally the dehumidifying filter 11a, the second sub-assembly having been prepositioned for example in the additional compartment 12. As mentioned above, the use of the mechanical connections to connect the first sub-assembly and the second sub-assembly makes it possible to reduce the volume of the refrigeration system significantly because there is no longer the need to use a flame which implies a substantial free volume around the parts to be soldered.

Preferably, the second connection 16 and the outlet connection 17 are devoid of a solder joint or weld joint.

Without limitation, the inlet connection 15, the first connection, the third connection 11b and/or the fourth connection 11c may further optionally comprise a solder joint or a weld joint, because the elements forming the first sub-assembly, respectively the second sub-assembly, of the refrigeration unit may be pre-assembled before the prepositioning of the first sub-assembly, respectively of the second sub-assembly, of the refrigeration unit in the confined space of the refrigerated compartment 2, respectively of the additional compartment 12.

In a second embodiment, the inlet connection 15 and the outlet connection 17 each comprise a mechanical connection comprising a crimping ring configured to connect the inlet duct and the corresponding outlet duct in a sealed manner.

A cocktail machine comprising a mechanical connection comprising a crimping ring configured to connect in a sealed manner, on the one hand, the evaporator 7 to the capillary 6 and, on the other hand, the evaporator 7 to the compressor 4 may advantageously be manufactured by connecting, without soldering and without welding, two sub-assemblies of the refrigeration unit prepositioned in the cocktail machine: a third sub-assembly comprising the evaporator 7, the evaporator 7 having been prepositioned at least partially inside the refrigerated compartment 2, and a fourth sub-assembly comprising the compressor 4, the condenser 5, optionally the dehumidifying filter 11a and the capillary tube 6, the second sub-assembly having been prepositioned for example in the additional compartment 12. As mentioned above, the use of the mechanical connections to connect the third sub-assembly and the fourth sub-assembly makes it possible to reduce the volume of the refrigeration system significantly because there is no longer the need to use a flame which implies a substantial free volume around the parts to be soldered.

Preferably, the inlet connection 15 and the outlet connection 17 are devoid of a solder joint or weld joint.

Without limitation, the first connection, the second connection 16, the third connection 11b and/or the fourth connection 11c may further optionally comprise a solder joint or a weld joint, because the elements forming the third sub-assembly, respectively the fourth sub-assembly, of the refrigeration unit may be pre-assembled before the prepositioning of the third sub-assembly, respectively the fourth sub-assembly, of the refrigeration unit in the confined space of the refrigerated compartment 2, respectively of the additional compartment 12.

Furthermore, in the first embodiment or in the second embodiment, each duct among the inlet duct 8 of the evaporator 7, the outlet duct 9 of the evaporator 7, the inlet duct of the compressor 4, the outlet duct of the compressor, the inlet duct of the condenser 5, the inlet duct of the capillary tube 6 and the outlet duct of the capillary tube 6, may comprise one or more duct sections, where a duct section is connected to a connecting duct section which is adjacent thereto, in a sealed manner, the connection comprising a mechanical part, a solder joint or a weld joint.

Each section of inlet duct 8 of the evaporator 7, the outlet duct 9 of the evaporator 7, the inlet duct of the compressor 4, the outlet duct of the compressor 4, the inlet duct of the condenser 5, the outlet duct of the condenser 5, the inlet duct of the capillary tube 6 and/or the outlet duct of the capillary tube 6 is typically made of metal, for example copper.

Each section of the inlet duct 8 of the evaporator 7, the outlet duct 9 of the evaporator 7, the inlet duct of the compressor 4, the outlet duct of the compressor 4, the inlet duct of the condenser 5, the outlet duct of the condenser 5, the inlet duct of the capillary tube 6 and/or the outlet duct of the capillary tube 6 may have a linear shape or a curved shape making it possible to obtain a more compact refrigeration unit.

### Mechanical Connections

Hereinafter, an example of a mechanical connection (not shown) will be described in the case where the mechanical connections are used to connect, on the one hand, the outlet duct of the condenser 5 to the capillary tube 6 and, on the other hand, the outlet duct 9 of the evaporator 7 to the inlet duct of the compressor 4. However, this is not limiting, as has just been stated.

As mentioned above, the outlet duct of the condenser 5 and the inlet duct of the capillary tube 6 are connected via a second mechanical connection 16 and the outlet duct 9 of the evaporator 7 and the inlet duct of the compressor 4 are connected via an outlet mechanical connection 17 each comprising a crimping ring 101. Each crimping ring 101 is configured to connect the inlet duct 102 and the corresponding outlet duct 103 in a sealed manner. Two exemplary embodiments of a mechanical connection according to the invention are described hereinafter. It will of course be understood that any other type of tight mechanical connection may, however, be implemented.

In an exemplary embodiment, the mechanical connection 16, 17 further comprises a coupling body and an additional crimping ring; each of the two ducts connected by said mechanical connection 16, 17 is engaged with a respective sleeve of the coupling body and each crimping ring is configured to connect, in a sealed manner, one of the two ducts and the sleeve of the coupling body 162, 172 with which said pipe is engaged.

Typically, an outer, respectively inner surface of each of the two sections connected by the mechanical connection 16, 17 is in contact with an inner, respectively outer surface of the respective sleeve of the coupling body. Preferably, a layer of adhesive is disposed between the outer surface and the inner surface.

For example, the coupling body further comprises at least one circumferential flange, each circumferential flange being successively disposed between the respective sleeves of the coupling body and each crimping ring is disposed abutting the facing circumferential flange. Additionally or alternatively, the coupling body may further comprise one or more circumferential seals on the inner, respectively outer, surface of one and/or the other of the respective sleeves engaged with the corresponding duct section, to improve the tightness of the mechanical connection 16, 17.

For example, the mechanical connection 16 and/or 17 is a Lokring Vulkan double-ring connector from LOKRING TECHNOLOGY as described in US application 2007/0108760A1 or in US application 2005/0264006 A1 and advantageously makes it possible to avoid using any solder or weld joint.

According to one exemplary embodiment, the two duct sections 102, 103 which are connected by the mechanical connection 16 and/or 17 are engaged one inside the other, the crimping ring 101 being configured so as to connect and seal tightly the two duct sections 102, 103 engaged one inside the other.

For example, the mechanical connection 16 and/or 17 is a Lokring single-ring connector from Vulkan as described in US application 2008/0122223 A1 and advantageously makes it possible to avoid using any solder or weld joint. Such a mechanical connection has the advantage of being less expensive and more reliable than other mechanical connections that would include seals capable of being degraded over time.

### Cocktail Dispensing Network

The cocktail machine 1 is preferably configured to mix fluids from different receptacles in order to deliver cocktails. Typically, the cocktail machine 1 may comprise at least one hydraulic circuit and a dispensing head 18, the at least one hydraulic circuit being configured to:
withdraw a volume of a fluid contained in at least one fluid container 3 stored in the refrigerated compartment 2, typically an ingredient of a cocktail to be prepared, and
convey the volume thus withdrawn to the dispensing head,
   the dispensing head 18 being configured to deliver said volume into a final receptacle 19, typically a glass of the machine user.

Preferably, the cocktail machine 1 comprises an independent hydraulic circuit for each fluid container 3 stored in the refrigerated compartment 2, such that the different ingredients are only mixed in the final receptacle 19 of the machine user.

Each hydraulic circuit typically comprises a pump 20, preferably a peristaltic pump which advantageously makes it possible to deliver very small volumes of fluid.

All of the pumps 20 of the cocktail dispensing network may be disposed in an additional compartment 100 of the cocktail machine 1.

### Manufacturing Method

An exemplary method for manufacturing a cocktail machine 1 comprises the following steps:
disposing (E1) the refrigeration unit in the cocktail machine 1, and
connecting in a sealed manner (E2) the second connection (16) and the outlet connection (17), and/or the outlet connection (17) and the inlet connection (15) to the corresponding inlet and outlet ducts via mechanical connections comprising a crimping ring (101)

### Disposing (E1) the Refrigeration Unit in the Cocktail Machine 1

In a first embodiment, disposing (E1) the refrigeration unit in the cocktail machine 1 may comprise the following sub-steps:
manufacturing (E1°) the first sub-assembly of the refrigeration unit comprising successively connected the capillary tube 6 and the evaporator 7,
assembling (E1′) the refrigerated compartment 2 with the first sub-assembly of the previously manufactured unit 3,
manufacturing (E1″) the second sub-assembly of the refrigeration unit comprising, successively connected, the condenser 5 and the compressor 4,
disposing (E1″) the second sub-assembly of the previously manufactured refrigeration unit relative to the refrigerated compartment 2.

According to this first embodiment of the step of disposing (E1) the refrigeration unit in the cocktail machine 1, manufacturing (E1°) the first sub-assembly of the refrigeration unit comprises the connection of the outlet duct of the capillary tube 6 with the inlet duct of the evaporator 7 via the inlet connection. The connection of the outlet duct of the capillary tube 6 with the inlet duct of the evaporator 7 may comprise implementing a weld or a solder between the inlet duct and the corresponding outlet duct, because the capillary tube 6 and the evaporator 7 are not yet disposed in the confined space of the cocktail machine, for example in the refrigerated compartment 2. Manufacturing (E1°) the first sub-assembly of the refrigeration unit may further comprise, prior to their connection, manufacturing the capillary tube 6 and/or the evaporator 7. The method for manufacturing the capillary tube 6 and/or the evaporator 7 may optionally comprise implementing welds and/or solders, because the different elements of the capillary tube 6 and the evaporator 7 are not yet disposed in the confined space of the cocktail machine, for example in the refrigerated compartment 2. A person skilled in the art is capable of determining the order in which the elements of the capillary tube 6 and of the evaporator 7 should be formed and connected, optionally by welding or soldering, so as not to damage other elements of the first sub-assembly of the refrigeration unit.

Manufacturing (E1″) the second sub-assembly of the refrigeration unit comprises the connection of the outlet duct of the compressor 4 with the inlet duct of the condenser 5 via the first connection. The connection of the outlet duct of the compressor 4 with the inlet duct of the condenser 5 may comprise implementing a weld or a solder between the inlet duct and the corresponding outlet duct, because the compressor 4 and the condenser 5 are not yet disposed in the confined space of the cocktail machine, for example in the additional compartment 12. Manufacturing (E1″) the fourth sub-assembly of the refrigeration unit may further comprise, prior to their connection, manufacturing the condenser 5 and/or the compressor 4. For example, manufacturing the condenser 5 may comprise manufacturing the outlet duct of the condenser 5 by the connection of an upstream section to an intermediate section forming a dehumidifying filter 11a, for example by a connection 11b comprising a crimping ring, and the connection of the intermediate section to a downstream section for example by a connection 11c comprising a solder joint. The method for manufacturing the compressor 4 and/or the condenser 5 may optionally comprise implementing welds and/or solders, because the different elements of the compressor 4 and of the condenser 5 are not yet disposed in the confined space of the cocktail machine, for example in the additional compartment 12. A person skilled in the art is capable of determining the order in which the elements of the compressor 4 and of the condenser 5 should be formed and connected, optionally by welding or soldering, so as not to damage other elements of the second sub-assembly of the refrigeration unit.

The sub-steps of manufacturing (E1°) the first sub-assembly of the refrigeration unit and assembling (E1′) the refrigerated compartment 2 with the previously manufactured first sub-assembly may be implemented prior to, concurrently with or subsequent to the sub-steps of manufacturing (E1″) and disposing (E1″) the second sub-assembly of the refrigeration unit. Typically, disposing (E1″) the second sub-assembly in the cocktail machine 1 may comprise disposing said second sub-assembly in one or more compartments of the cocktail machine 1 separate from the refrigerated compartment 2, typically in the additional compartment 12, and assembling (E1′) the refrigerated compartment 2 with the first sub-assembly of the refrigeration unit may comprise:
disposing at least one section of a cooling duct of the evaporator 7 inside the refrigerated compartment 2,
passing at least the capillary tube 6 (and optionally the inlet duct 8 of the evaporator 7 connected to the capillary tube 6) and the outlet duct 9 of the evaporator 7 through at least one passage orifice 22 of a connecting wall 21 of the refrigerated compartment 2, such that the outlet duct of the capillary tube 6 and the outlet duct 9 of the evaporator 7 open into one or two compartments of the cocktail machine 1 separate from the refrigerated compartment 2, for example into the additional compartment 12.
   According to this embodiment, connecting in a sealed manner (E2) the outlet duct of the capillary tube 6 and the outlet duct 9 respectively to the outlet duct of the condenser 5 and the inlet duct of the compressor 4, via respectively the second connection 16 and the outlet connection 17 is implemented in the compartment(s) of the cocktail machine separate from the refrigerated compartment 2, for example in the additional compartment 12.

Alternatively, the method comprises-passing the inlet duct of the compressor 4 and at least the capillary tube 6 (and optionally the inlet duct 8 of the evaporator 7 connected to the capillary tube 6) through at least the passage orifice 22 of the connecting wall 21 of the refrigerated compartment 2, such that the inlet duct of the compressor 4 and the outlet duct of the capillary tube 6 respectively open into the refrigerated compartment 2 and, into another compartment of the cocktail machine 1, for example into the intermediate compartment 12.

In a second embodiment, disposing (E1) the refrigeration unit in the cocktail machine 1 may comprise the following sub-steps:
assembling (E1′) the refrigerated compartment 2 with the evaporator 7,
manufacturing (E1″) the fourth sub-assembly of the refrigeration unit comprising, successively connected, the capillary tube 6, the condenser 5 and the compressor 4,
disposing (E1″) the fourth sub-assembly of the previously manufactured refrigeration unit relative to the refrigerated compartment 2.

According to this second embodiment of the step of disposing (E1) the refrigeration unit in the cocktail machine 1, manufacturing (E1″) the sub-assembly of the refrigeration unit comprises the connection of the outlet duct of the compressor 4 with the outlet duct of the condenser 5 via the first connection and the connection of the outlet duct of the condenser 5 with the inlet duct of the capillary tube 6 via the second connection. The connection of the outlet duct of the compressor 4 with the inlet duct of the condenser 5 and/or the connection of the outlet duct of the condenser 5 with the inlet duct of the capillary tube 6 may comprise implementing a weld or a solder between the inlet duct and the corresponding outlet duct, because the capillary tube 6, the compressor 4 and the condenser 5 are not yet disposed in the confined space of the cocktail machine, for example in the additional compartment 12. Manufacturing (E1″) the fourth sub-assembly of the refrigeration unit may further comprise, prior to their connection, manufacturing the capillary tube 6, the condenser 5 and/or the compressor 4. For example, manufacturing the condenser 5 may comprise manufacturing the outlet duct of the condenser 5 by the connection of an upstream section to an intermediate section forming a dehumidifying filter 11a, for example by a connection 11b comprising a crimping ring, and the connection of the intermediate section to a downstream section for example by a connection 11c comprising a solder joint. The method for manufacturing the capillary tube 6, the compressor 4 and/or the condenser 5 may optionally comprise implementing welding or soldering, because the different elements of the capillary tube 6, of the compressor 4 and of the condenser 5 are not yet disposed in the confined space of the cocktail machine, for example in the additional compartment 12. A person skilled in the art is capable of determining the order in which the elements of the capillary tube 6, of the compressor 4 and of the condenser 5 should be formed and connected, optionally by welding or soldering, so as not to damage other elements of the fourth sub-assembly of the refrigeration unit.

The sub-step of assembling (E1′) the refrigerated compartment 2 with the evaporator 7 may be implemented prior to, concurrently with or subsequent to the steps of manufacturing (E1″) and disposing (E1′″) the fourth sub-assembly of the refrigeration unit.

Typically, disposing (E1′″) the fourth sub-assembly may comprise disposing said fourth sub-assembly in one or more compartments of the cocktail machine 1 separate from the refrigerated compartment 2, typically in the additional compartment 12, and assembling (E1′) the refrigerated compartment 2 with the evaporator 7 may comprise:
disposing at least one section of a cooling duct of the evaporator 7 inside the refrigerated compartment 2,
passing the outlet duct of the outlet duct 9 of the evaporator 7 through at least one passage orifice 22 of a connecting wall 21 of the refrigerated compartment 2, such that the outlet duct 8 and the outlet duct 9 of the evaporator 7 open into one or two compartments of the cocktail machine 1 separate from the refrigerated compartment 2, for example into the additional compartment 12.

According to this embodiment, connecting in a sealed manner (E2) the outlet duct 8 and the outlet duct 9 respectively to the outlet duct of the capillary tube 6 and the inlet duct of the compressor 4, via respectively the inlet connection 15 and the outlet connection 17 is implemented in the compartment(s) of the cocktail machine separate from the refrigerated compartment 2, for example in the additional compartment 12.

Alternatively, assembling (E1′) the refrigerated compartment 2 with the evaporator 7 may comprise disposing said evaporator 7 inside the refrigerated compartment 2 and disposing (E1″′) the fourth sub-assembly of the refrigeration unit may comprise:
disposing the fourth sub-assembly of the refrigeration unit inside one or more compartments of the cocktail machine separate from the refrigerated compartment 2, for example inside the additional compartment 12,
passing the outlet duct of the capillary tube 6 and the inlet duct of the compressor 4, through at least the passage orifice 22 of the connecting wall 21 of the refrigerated compartment 2, such that the outlet duct of the capillary tube 6 and the inlet duct of the compressor 4 open into the refrigerated compartment 2.
   According to this embodiment, connecting in a sealed manner (E2) the inlet duct 8 and the outlet duct 9 respectively to the outlet duct of the capillary tube 6 and the inlet duct of the compressor 4, via respectively the inlet connection 15 and the outlet connection 17 is implemented in the refrigerated compartment 2.

Also alternatively, the two embodiments described above may be combined, such that the method comprises:
passing the outlet duct of the capillary tube 6 and the outlet duct 9 of the evaporator 7 through at least the passage orifice 22 of the connecting wall 21 of the refrigerated compartment 2, such that the outlet duct of the capillary tube 6 and the outlet duct 9 of the evaporator 7 respectively open into the refrigerated compartment 2 and into another compartment of the cocktail machine 1, for example into the intermediate compartment 12, or,
passing the inlet duct of the compressor 4 and the inlet duct 8 of the evaporator 7 through at least the passage orifice 22 of the connecting wall 21 of the refrigerated compartment 2, such that the inlet duct of the compressor 4 and the inlet duct 8 of the evaporator 7 respectively open into the refrigerated compartment 2 and, into another compartment of the cocktail machine 1, for example into the intermediate compartment 12.

### Connection (E2)

The connection (E2) makes it possible to connect the first sub-assembly of the refrigeration unit to the second sub-assembly of the refrigeration unit, or the evaporator 7 to the fourth sub-assembly of the refrigeration unit previously disposed in the cocktail machine 1 according to any of the embodiments described above.

As mentioned above, tight connection (E2) advantageously makes it possible to avoid using any welding or soldering step once the sub-assemblies of the unit are prepositioned in the cocktail machine 1. Thus, very preferably, connection (E2) is devoid of such a welding or soldering step. Exemplary embodiments of the connection step (E2) according to the invention, without being limited thereto, are described hereinafter.

According to a particular embodiment, the connection step (E2) may comprise:
optionally, applying an adhesive (E2′a) on an outer surface of each of the two ducts intended to be connected by the mechanical connection,
engaging (E2″) each duct covered with adhesive in a respective sleeve of the same coupling body, the crimping ring and an additional crimping ring having been previously engaged around each duct,
pushing (E2′″) each crimping ring, so as to slide it until the respective duct and sleeve are mechanically connected and sealed together, for example by a pressure applied by the crimping ring around the duct engaged with the respective sleeve inducing at least one local deformation of the duct and the respective sleeve engaged one in the other.

Alternatively, the connection step may comprise applying an adhesive (E2′b) on an outer surface of each sleeve of the coupling body, engaging each duct intended to be connected with a respective sleeve previously covered with adhesive, the crimping ring and the additional crimping ring having previously been engaged around each duct and pushing each crimping ring as described above.

Applying adhesive (E2′a), (E2′b) advantageously makes it possible to fill surface irregularities between the outer surface of each duct section and the corresponding sleeve, and thus improve the tightness of each mechanical connection.

For example, during step (E2∝″), each crimping ring is pushed up to an abutment position of the coupling body, by any suitable pushing means. For example, the coupling body may comprise one or two circumferential flanges disposed successively between the sleeves of the coupling body. In this configuration, each crimping ring may be pushed against a circumferential flange of the coupling body facing said crimping ring. For example, the crimping ring is pushed against the circumferential flange by means of a gripper. Typically, each jaw of the gripper is initially arranged so as to frame together the crimping ring and the circumferential flange. Then the gripper jaws are tightened so as to push the crimping ring against the circumferential flange.

According to another embodiment, the connection step (E2) may comprise:
engaging one of the two ducts 103 intended to be connected by the mechanical connection inside the other pipe 102 of the two pipes, the crimping ring 101 having been previously engaged, for example around the large-diameter section 102,
pushing the crimping ring 101, so as to slide said crimping ring 101 until the tight mechanical connection is established.

Optionally, engaging the small-diameter duct 103 inside the large-diameter pipe 102 may be preceded by applying an adhesive on an outer surface of the small-diameter pipe 103. Applying adhesive advantageously makes it possible to fill surface irregularities between the outer surface of the small-diameter duct and an inner surface of the large-diameter duct and thus improve the tightness of each mechanical connection.

The crimping ring may be pushed by any suitable pushing means, for example a gripper.

### Positioning of a Fan (E3)

The manufacturing method may further comprise an additional step (E3) of disposing a fan 13 configured to cool the condenser 5. The additional step (E3) may be implemented before, concurrently with or after the step of disposing (E1) the refrigeration unit in the cocktail machine 1 or the connection step (E2).

When the fan 13 and the condenser respectively comprise a housing 131 and a housing 51, the additional step (E3) may comprise fastening the housing 131 with the housing 51 by any suitable fastening means, for example by means of screws.

1. A cocktail machine comprising:
a refrigerated compartment configured to accommodate at least one fluid container,
a refrigeration unit comprising a compressor configured to compress a heat transfer fluid, a condenser configured to condense the heat transfer fluid into a liquid, expansion means configured to reduce a temperature of the liquid, an evaporator adjacent to the refrigerated compartment and configured to transfer heat from the refrigerated compartment to the liquid, and a heat transfer network configured to place the compressor, the condenser, the expansion means and the evaporator in fluidic communication, the heat transfer network comprising a first connection configured to connect an outlet duct of the compressor and an inlet duct of the condenser, a second connection configured to connect an outlet duct of the condenser and an inlet duct of the expansion means, an inlet connection configured to connect an outlet duct of the expansion means and an inlet duct of the evaporator, and an outlet connection configured to connect an outlet duct of the evaporator and an inlet duct of the compressor,
wherein the second connection and the outlet connection, and/or the outlet connection and the inlet connection, each comprise a mechanical connection comprising a crimping ring configured to connect the inlet duct and the corresponding outlet duct in a sealed manner.

2. The cocktail machine according to claim 1, wherein connection of the mechanical connections to the corresponding inlet and outlet ducts is devoid of a solder or weld joint.

3. The cocktail machine according to claim 1, wherein the second connection and the outlet connection comprise the mechanical connection, the inlet connection comprising a solder joint.

4. The cocktail machine according to claim 1, wherein the evaporator is arranged inside the refrigerated compartment, a first wall of the refrigerated compartment comprising at least one passage orifice, the inlet duct (8) and/or the outlet duct of the evaporator passing through said at least one passage orifice.

5. The cocktail machine according to claim 4, wherein the evaporator comprises a first plate and a second plate (72) fastened against the first plate, at least the first plate comprising a recess, such that said recess forms a duct for circulating the heat transfer fluid in the evaporator, the evaporator being disposed against an inner surface of a second wall of the refrigerated compartment.

6. The cocktail machine according to claim 1, wherein the compressor comprises a rechargeable battery.

7. The cocktail machine according to claim 1, further comprising a fan configured to cool the condenser.

8. The cocktail machine according to claim 7, further comprising an additional compartment comprising an evacuation grille, the condenser, the compressor and the fan being disposed inside said additional compartment, the condenser being arranged between the fan and the evacuation grille.

9. The cocktail machine according to claim 7, wherein an axis of rotation of the fan is perpendicular to a main plane of a heating duct of the condenser, and wherein the inlet duct and the outlet duct of the condenser are each arranged between the fan and the evacuation grille.

10. The cocktail machine according to claim 7, wherein the condenser comprises a housing, the fan being mounted on the housing of the condenser.

11. A method for manufacturing a cocktail machine according to claim 1, comprising the following steps:
arranging the refrigeration unit in the cocktail machine, and
connecting in a sealed manner the second connection and the outlet connection, and/or the outlet connection and the inlet connection to the corresponding inlet and outlet ducts via mechanical connections comprising a crimping ring.

12. The manufacturing method according to claim 11, further comprising arranging a fan in an additional compartment comprising an evacuation grille, such that the condenser is arranged between the fan and the evacuation grille.

13. The manufacturing method according to claim 11, comprising, prior to arranging the refrigeration unit in the cocktail machine and connecting in a sealed manner the second connection and the outlet connection, on the corresponding inlet and outlet ducts via the mechanical connections:
soldering or welding the first connection so as to connect the outlet duct of the compressor and the inlet duct of the condenser, and
soldering or welding the inlet connection so as to connect the outlet duct of the expansion means to the inlet duct of the evaporator.

14. The manufacturing method according to claim 11, comprising, prior to arranging the refrigeration unit in the cocktail machine and connecting in a sealed manner the outlet connection and the inlet connection, on the corresponding inlet and outlet ducts via the mechanical connections:
soldering or welding the first connection so as to connect the outlet duct of the compressor and the inlet duct of the condenser, and
soldering or welding the second connection so as to connect the outlet duct of the condenser and the inlet duct of the expansion means.
